(19) United States
(12) Patent Application Publication
(10) Pub. No.: US 2006/0026208 A1
(43) Pub. Date: Feb. 2, 2006

(54) System and method for automatically generating an image-file

(75) Inventor: Shang-Qing Zhou, Shen-Zhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/189,287

(22) Filed: Jul. 26, 2005

(30) Foreign Application Priority Data
Jul. 30, 2004 (TW) 93122898

(51) Int. Cl. G06F 17/00

(52) U.S. Cl. 707/104.1

(57) ABSTRACT

A system for automatically generating an image file is disclosed. The system includes an application server (1), a database (5) connected to the application server through a connection (2), and a plurality of client computers (6) linked to the application server via a network (3). The application server includes a component list generating module (10) and a component downloading module (12). The client computer includes an image file generating module (60) and an image file transmitting module (62). A related method is also disclosed.

### BACKGROUND OF THE INVENTION

1. Field of the Invention

The present invention relates to a method and system for making an image file of an operating system in a recovery disc.

2. General Background

In recent years, personal computers have become an integral necessity in both the work and home environment. For many people, personal computers have become their main communication system, which can be used for sending and receiving electronic mail (i.e., e-mail), transferring files over a local area network (LAN), and communicating over the world wide web via the Internet. Because people have placed such a high level of dependence on their personal computers, when a failure (i.e., crash) to either a hardware or software component occurs, the user will generally suffer greatly in terms of productivity loss.

Many times, failures to either hardware or software components can lead to the complete loss of personal data, which often cannot be recovered using standard data recovery tools. In order to satisfy the demand for safety of personal data, a variety of techniques have been developed. During the production of a computer system, the manufacturer usually installs an operating system (OS) in a data storage device, such as the hard disk of the computer system. The operating system includes related hardware device drivers and applications. The manufacturer generally installs an OS image file in the hard disk of the computer system, and the computer system will unpack the OS image file in the hard disk to pre-setup the operating system when users first power on the computer system.

However, when the hardware device was damaged or infect virus, then all the personal data will not recovered only by the OS image file in the hard disk. Furthermore, the OS image file occupied much space of the hardware device. In contrast, if there are accompanied CDs which install OS image files, we can solve the problems easily. Therefore, a system disc (SCD) and a recovery disc (RCD) are usually accompanied with the computer system provided to users. The system disc includes patch files, applications and drivers. The recovery disc includes bootable files and an OS image file. When the hardware device drivers and applications of the computer system are to be updated, the manufacturer places the patch files (updated files) into the system disc. Users may use the system disc to update corresponding hardware device drivers and applications.

In the process of making the SCD or RCD, it usually involves the following steps: users manually select a file or a folder, and copy the file or the folder to appointed destination address; repeat the above step till all files and folders are copied to their corresponding destination address; convert the copied files and folders into an ISO9660 format which is a standard for the data of CDs for obtaining an image file. However, when there are so many files and folders need to be copied by the users, the making process occupies plenty of time, and leads to many manual errors.

Therefore, what is needed is a system and method for automatically generating an image file, by which the users can directly install the image file in CDs.

### SUMMARY

A system for automatically generating an image file in accordance with a preferred embodiment of the present invention. The system comprises an application server, a database connected to the application server through a connection, and a plurality of client computers linked to the application server via a network. The database stores a plurality of components. Each component may include a single target file and its corresponding script file which records actions executed by the target file. Furthermore, the component may include a folder and its corresponding script file which records actions executed by the folder. The client computers collaborate with the application server to generate an image file. The application server includes a component list generating module and a component downloading module. The client computer includes an image file generating module. The component list generating module is for generating a component list; the component downloading module is for downloading components according to the component list; the image file generating module is for generating the image file by converting the downloaded components into ISO9660 format.

Further, a preferred method for automatically generating an image file is also provided. The method includes the steps of: receiving component names input by users; extracting a source address of the components according to the component names; generating a component list; downloading the components according to the component list; and generating an image file by converting the downloaded components into ISO9660 format.

Other advantages and novel features of the present invention will be drawn from the following detailed description of a preferred embodiment and preferred method with the attached drawings, in which:

### BRIEF DESCRIPTION OF THE DRAWINGS

FIG. 1 is a schematic diagram of hardware configuration of a system for automatically generating an image file in accordance with a preferred embodiment of the present invention;

FIG. 2 is a schematic diagram showing function modules of an application server and a client computer of FIG. 1; and

FIG. 3 is flowchart of a preferred method for automatically generating an image file by utilizing the system of FIG. 1.

### DETAILED DESCRIPTION OF THE PREFERRED EMBODIMENTS

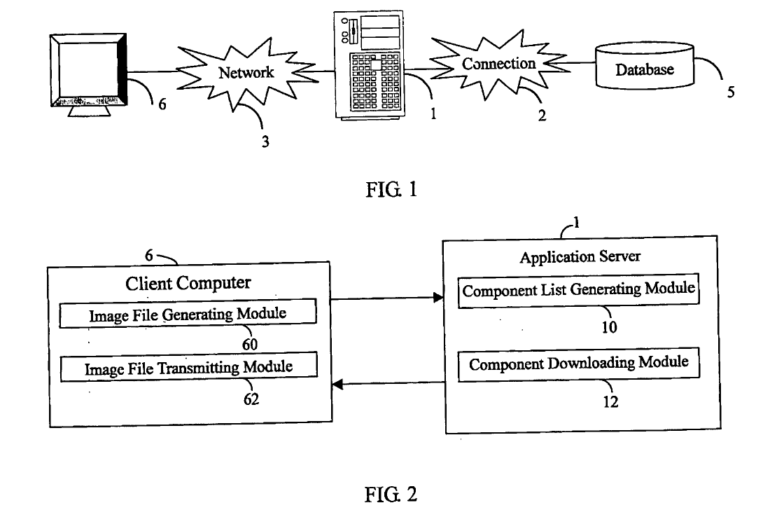

FIG. 1 is a schematic diagram of hardware configuration of a system for automatically generating an image file of an operating system (hereinafter, “the system”) in accordance with a preferred embodiment of the present invention. The system comprises an application server 1, a database 5 connected to the application server 1 through a connection 2, and a plurality of client computers 6 (only one shown) linked to the application server 1 via a network 3. The network 3 may be an intranet, the Internet, or any other suitable electronic communications network. The connection 2 is a database connectivity such as an Open Database Connectivity (ODBC) or a Java Database Connectivity (JDBC).

The database 5 stores a plurality of components. Each component may include a single target file and its corresponding script file which records actions executed by the target file. Furthermore, the component may include a folder and its corresponding script file which records actions executed by the folder. Each of the target file and the folder may be any one of an application program, a driver program, a setting program, a utility program and so on. The client computers 6 may be general-purpose computer devices such as personal computers, laptops and portable handheld devices, mobile phones or other suitable electronic communication terminals. The client computers 6 collaborated with the application server 1 to generate an image file. The image file is an ISO9660 format file. ISO9660 format is a standard for the data of CDs. The standard describe how data (the components) is archived.

FIG. 2 is a schematic diagram showing function modules of the application server 1 and one client computer 6. The application server 1 includes a component list generating module 10 and a component downloading module 12. The client computer 6 includes an image file generating module 60 and an image file transmitting module 62. After users input all component names and their corresponding destination address in the client computer 6 where the components may be downloaded, the component list generating module 10 extracts a source address where the components located according to the component names, and generates a component list. The component list typically includes the component names, and the source address and destination address of the components. The component downloading module 12 extracts the components according to the source address, and downloads the components from the source address to the destination address. Then, the image file generating module 60 converts the components into an image file. The image file is in ISO9660 format. The image file transmitting module 62 transmits the image file to the application server 1. Then the users can record the image file in recovery discs, such as CDs.

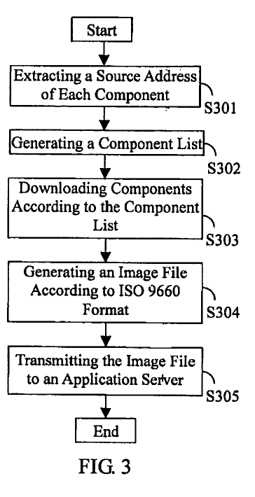

FIG. 3 is a flowchart of a preferred method for automatically generating an image file of an operating system in a recovery disc by utilizing the system. In step S301, a user inputs all component names and its corresponding destination address where the component may be downloaded. Then, the component list generating module 10 extracts a source address where the components located according to the component names. In step S302, the component list generating module 10 generates a component list. The component list typically includes the input component names, and the source address and destination address of the components. In step S303, the component downloading module 12 extracts the components according to the source address, and downloads the components from the source address to the destination address in the client computer 6. In step S304, the image file generating module 60 converts the components into an image file which is ISO9660 format. In step S305, the image file transmitting module 62 transmits the image file to the application server 1, in order to record the image file in the recovery disc.

Although the present invention has been specifically described on the basis of a preferred embodiment and preferred method, the invention is not to be construed as being limited thereto. Various changes or modifications may be made to the embodiment and method without departing from the scope and spirit of the invention.

We claim:

1. A system for automatically generating an image file, the system comprising:
a component list generating module for generating a component list;
a component downloading module for downloading components according to the component list; and
an image file generating module for generating an image file by converting the downloaded components into ISO9660 format.

2. The system according to claim 1, wherein the component list generating module is further used for extracting a source address of the components according to component names input by users.

3. The system according to claim 2, wherein the component list comprises the component names, and the source address and destination address of the components.

4. The system according to claim 1, wherein the ISO9660 format is a standard for the data of CDs.

5. A computer-based method for automatically generating an image file, comprising the steps of:
receiving component names input by users;
extracting a source address of the components according to the component names;
generating a component list;
downloading the components according to the component list; and
generating an image file by converting the downloaded components into ISO9660 format.

6. The method according to claim 5, wherein the component list comprises the component names, and the source address and destination address of the components.

7. A method for creating image files to be recorded in one of system and recovery storage media, comprising the steps of:
retrieving information of target components of a predetermined image file according to user definition;
generating a component list containing said information and source addresses of said target components;
retrieving said target components based on said component list and source addresses of said target components; and
creating said image file containing said target components compatible to said user definition.

8. The method according to claim 7, wherein said image files are compatible to an ISO9660 format for being recordable in compact discs (CDs).

9. The method according to claim 7, wherein said information of said target components includes names of said target components and a destination address where said target components are processed.
